(19) United States
(12) Patent Application Publication
(10) Pub. No.: US 2011/0268997 A1
(43) Pub. Date: Nov. 3, 2011

(54) BATTERY HAVING SIMPLIFIED DESIGN

(75) Inventors: Christian Gaugler, Ellwangen (DE); Kuno Gross, Adelmannsfelden (DE); Rainer Hahn, Jagstzell (DE)

(73) Assignee: VARTA Microbattery GmbH, Hannover (DE)

(21) Appl. No.: 13/124,538

(22) PCT Filed: Jan. 22, 2010
(86) PCT No.: PCT/EP2010/000390

§ 371 Date: May 25, 2011

(30) Foreign Application Priority Data
Jan. 26, 2009 (DE) 10 2009 007 249.7

(51) Int. Cl. H01M 10/42; H01M 10/04

(52) U.S. Cl. 429/7; 29/623.2

(57) ABSTRACT

A battery comprising a cell stack comprising at least one individual cell in a cell housing, an electronic component part, electrical conductors between the cell stack and the electronic component part and an injection-molded part which substantially completely surrounds the electrical conductors and is connected in form-fitting fashion both the cell stack and to the electronic component part and connects the cell stack and the electronic component part to one another, outer contact faces of the battery also being integrated in the electronic component part in addition to at least one electronic circuit.

### CROSS-REFERENCE TO RELATED APPLICATIONS

This is a 371 of International Application No. PCT/EP2010/000390, with an international filing date of Jan. 22, 2010, which is based on German Patent Application No. 10 2009 007 249.7, filed Jan. 26, 2009, the subject matter of which is incorporated by reference.

### TECHNICAL FIELD

This disclosure related to a battery, in particular a rechargeable battery, as is used, for example, in mobile telephones and other portable devices.

### BACKGROUND

Such batteries, often also referred to as “power packs,” generally always comprise a cell stack comprising one or more individual cells which are preferably arranged in stacked or wound form in a cell housing. Further elements are generally in particular electronic components such as protective circuits and various electrical conductors, with which the cell stack and the electronic components are brought into contact with one another. Electrical energy is supplied or drawn generally via preferably metallic contact faces, which are located on one of the outer sides of the battery. Such contact faces can be incorporated in a plastics housing, for example, in which, in turn, the cell stack and the above-mentioned electronic components and electrical conductors can be arranged. Remaining cavities within the housing can easily be filled with injection molding, for example.

Owing to the numerous individual steps which are involved when producing a battery with such a housing (insertion of the various individual components such as cell stack and electronic circuits into the housing and brining the components into contact with one another and with the outer contact faces incorporated in the housing), there are, however, often problems in terms of manufacture. Attempts have therefore been made to find technical solutions with which the manufacturing process can be simplified and therefore also expidited. The aim has been to provide batteries with reduced unit costs, without there being any loss of quality as a result of manufacture.

### SUMMARY

We provide a batter comprising a cell stack comprising at least one individual cell in a cell housing, an electronic component part, electrical conductors between the cell stack and the electronic component part and an injection-molded part which substantially completely surrounds the electrical conductors and is connected in form-fitting fashion both to the cell stack and to the electronic component part and connects the cell stack and the electronic component part to one another, outer contact faces of the battery also being integrated in the electronic component part in addition to at least one electronic circuit.

We also provide a method for producing a battery, wherein a cell stack comprising at least one individual cell in a cell housing and an electronic component part into which the outer contact faces of the battery are also integrated, in addition to at least one electronic circuit, are arranged in an injection mold and remaining free space in the mold is filled with a liquid plastics compound which is then cured.

### BRIEF DESCRIPTION OF THE DRAWINGS

FIG. 1 shows an electronic component part which can be inserted with integrated outer contact faces and an integrated electronic circuit.

FIG. 2 shows an example of a battery.

### DETAILED DESCRIPTION

Our battery comprises a plurality of separate individual components, namely a cell stack comprising at least one individual cell in a cell housing, an electronic component part and electrical conductors between the cell stack and the electronic component part which are used to bring the cell stack and electronic component part into contact with one another. Furthermore, our battery comprises an injection-molded part, which has a plurality of functions at the same time. First, it protects and fixes the electrical conductors between the cell stack and the electronic component part, which conductors are embedded substantially completely in the injection-molded part. In this case, the injection-molded part is connected in form-fitting fashion both to the cell stack and to the electronic component part and connects the cell stack and the electronic component part to one another. The electronic component part itself is in this case in particular characterized by the fact that the outer contact faces of the battery are also integrated in the component part, in addition to at least one electronic circuit. The electronic circuit and the outer contact faces can therefore be constructed in one step during the production of the battery. They are both an element of the same component part.

Within the battery, the electronic component part is naturally always arranged in such a way that the contact faces come to lie on the outer side of the battery, with the result that it is possible for current to be drawn there by an external load.

The injection-molded part can simply be in the form of an intermediate piece between the cell stack and the electronic component part and can connect the cell stack and electronic component part to one another by adhesive bonding. Preferably, however, in addition or as an alternative, the injection-molded part forms a fixed mechanical linking element between the two components.

For example, the injection-molded part of the battery can preferably be in the form of a frame or a housing which surrounds at least part of the cell stack, in particular the corners and edges thereof. At the same time or as an alternative to this, it may be preferred for the injection-molded part of the battery to be in the form of a frame or a housing which surrounds at least part, in particular the corners and edges, of the electronic component part If both is the case, the injection-molded part forms a frame or a housing in which the cell stack and the electronic component part are fixed firmly. In particular, these two parts can then no longer be separated from one another without the injection-molded part being damaged or destroyed.

Preferably, the injection-molded part surrounds not only the corners and edges of the cell stack and/or the electronic component part, but surrounds the cell stack and/or electronic component part substantially completely (apart from the outer contact faces of the battery). A true housing is then formed which surrounds all of the components of the battery.

Preferably, the electronic component part can for its part substantially comprise a cured plastics part into which the outer contact faces of the battery and possibly the at least one electronic circuit and/or electrical conductors are embedded at least partially between the at least one circuit and the outer contact faces and/or the cell stack. However, the component part may also be a composite in which an electronic circuit component is fixed firmly, for example by adhesive bonding, on a cured plastics part with outer contact faces embedded therein. It is critical that the contact faces and the cell stack are part of a component part and can therefore be constructed in the same step.

The at lease one electronic circuit is particularly preferably and protective circuit, preferably a protective circuit with which discharging and in particular also charging operations can be monitored and controlled. Thus, for example when charging a rechargeable battery, care needs to be taken to ensure that the battery is not overcharged and thus reaches critical states. Possibly, the charging operation needs to be interrupted, a function which can be performed by an electronic protective circuit.

For this purpose, the battery can moreover also have further fuse means, for example fusible links. Suitable fuse means are known in the art and do not need to be explained in any more detail.

As has already been indicated at the outset, the battery preferably is a rechargeable battery. Particularly preferably, the battery is a lithium-ion batter or a lithium-polymer battery. Preferably, it correspondingly has at least one lithium-intercalating electrode.

The at least one individual cell in the cell stack is generally in the form of an electrode/separator composite, wherein the electrodes are applied to a flat separator, in particular to a separator film. A plurality of individual cells can be arranged, for example in the form of a stack, within the cell stack. As has already been mentioned at the outset, however, it is in principle also possible for the electrodes to be wound up, for example helically, together with the separator. In both cases, it is preferred for the individual cells to be surrounded by a water-tight housing to protect against moisture and other environmental influences. Preferably, thin films, in particular composite films such as aluminum composite films (with an insulating layer on the inner side), for example, are used as the housing material. The cell housing of the cell stack is correspondingly preferably a film housing.

To draw and output electrical energy, the at least one individual cell is preferably provided with current collectors, collectors of identical polarity possible being grouped together (if the cell stack comprises a plurality of individual cells) and connected to arrestors, which are passed out of the cell housing. If appropriate, these arrestors also form the electrical conductors between the cell stack and the electronic component part or are at least connected electrically conductively thereto.

As has already been mentioned, when producing the battery, the at least one electronic circuit and the outer contact faces can be constructed in one step. The battery consequently has a very simple design. Primarily, this has considerable advantages in terms of the manufacture of a battery, i.e. fewer individual components need to be connected to one another and fixed. Correspondingly, the method for producing a battery is also the subject matter of this disclosure.

In our method, a cell stack comprising at least one individual cell in a cell housing (in relation to possible examples of the cell stack and the components thereof, reference is made to the explanations above) and an electronic component part with the above-described embodiment (with an integrated electronic circuit and integrated outer contact faces of the battery, likewise as described above) are arranged in an injection mold. Then the remaining free space between the parts is filled with a liquid plastics compound. This is then cured (or the plastics compound is left to cure).

Since, in comparison with the prior art, fewer individual parts need to be inserted into the injection mold in our method, the procedure is considerably simplified, which in turn makes it possible to markedly reduce the length of the cycle times.

Prior to the liquid plastics compound being inserted into the injection mold, the individual parts arranged in the injection mold are connected to one another by electrical conductors, if necessary. This preferably takes place before the parts are arranged in the injection mold.

Particular preference is given to the use of a thermoplastic hotmelt adhesive as the plastics compound. Hotmelt adhesives on the basis of polyamide have proven to be particularly suitable.

Prior to the introduction of the plastics compound into the inject mold, the plastics compound and possible also the injection mold is/are heated, in particular to a temperature of between 150° C. and 280° C. Particularly preferred are temperatures in the range of between 190° C. and 230° C. Correspondingly, in particular also hotmelt adhesives are used which can be liquefied in the temperature ranges.

In the injection mold, the parts to be connected by injection molding are arranged corresponding to their desired position in the battery to be produced. In this case, the arrangement of the electronic component part is of particular significance since the contact faces integrated therein of the battery are naturally not intended to be covered by liquid plastics compound during the casting process. The electronic component part is therefore arranged in the injection mold preferably in such a way that the contact faces remain at least partially free from the liquid plastics compound. This takes place in particular by virtue of the fact that the electronic component part with the contact faces is pressed against the inner wall of the injection mold, with the result that no space remains between the contact faces and the surface of the injection mold into which the liquid plastics compound could pass.

Preferably, the cell stack is arranged in such a way that the liquid plastics compound can surround at least its corners and edges, in particular in such a way that an injection-molded part in the form of a frame or housing can be produced, as has been described above.

This and further features will be explained below in further detail with reference to the subsequent description relating to selected examples. Individual features can be implemented in each case individually or with one or more in combination with one another. The examples described merely serve to explain and provide better understanding and should not be understood to be restrictive in any way.

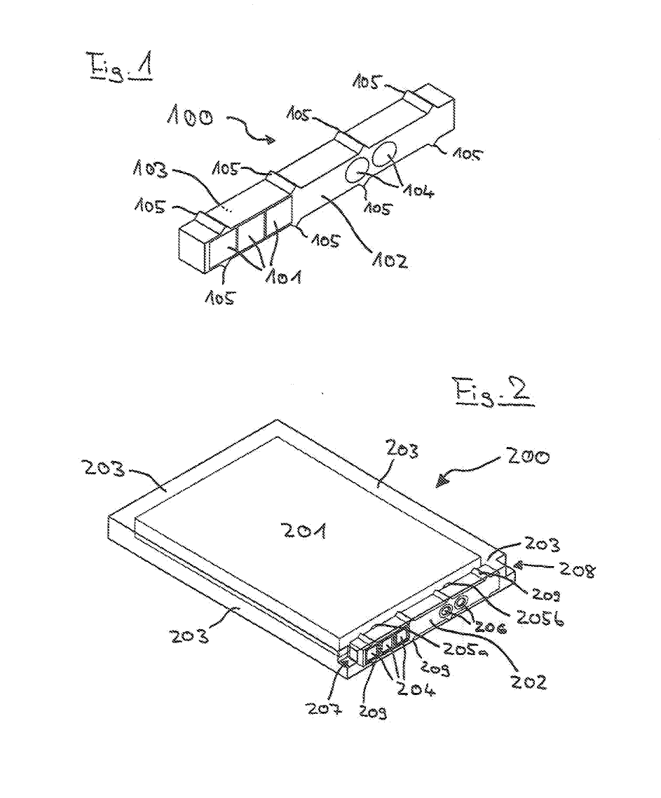

FIG. 1 illustrated a preferred example of an electronic component part 100 which can be inserted. The figure shows the outer contact faces 101 which are embedded in a plastics part comprising cured plastic 102. The electronic protection circuit 103 (not illustrated), which is connected fixedly to the plastics part, is arranged on the rear side of the plastics part 102 or embedded therein. The contact points for the electrical conductors (likewise not illustrated), via which the protection circuit 103 and the outer contact faces 101 can be connected to the cell stack of a battery, are also preferably located on the rear side of the plastics part. It is not essential here for contact to be made between the protection circuit 103 and the outer contact faces 101 or for them to be positioned precisely within the electronic component part 100 (or on the electronic component part). It is primarily important that the protection circuit 103 and the outer contact faces 101 are integrated in the electronic component part 100, i.e. that both are part of one and the same component part, with the result that they can be constructed in one step during production of a battery. The contacts 104 are test contacts, which are of no importance in relation to the invention described here.

The plastics body 102 of the electronic component part 100 is substantially in the form of a rectangular molded part. In total eight substantially triangular projections 105 can be seen on the longitudinal sides of the rectangular molded part. The projections act as positioning aids to be able to precisely position the component part 100 in an injection mold. The outer contact faces 101 can be pressed against the inner wall of the injection mold, for example by vacuum. Preferably, the component part 100 is fixed in the injection mold in a mechanical holder, however, in such a way that the contact faces bear against the inner wall under pressure. This can be preformed, for example, by thin pins arranged close to the inner wall of the injection mold, with the result that the electronic component part 100 can be clamped in between the pins and the inner wall. At the same time, pressure can be exerted on the contact faces via a contact-pressure plate.

FIG. 2 shows a schematic illustration of a battery 200. The figure shows, first, the cell stack 201, the electronic component part 202 illustrated in FIG. 1 with an integrated electronic circuit (not illustrated) and with the integrated outer contact faces 204 of the battery and the injection-molded part 203, which is connected in a form-fitting manner to the electronic component part and the cell stack. The cell stack 201 and the electronic component part 202 are connected electrically via the electrical conductor 205a and 205b. The injection-molded part 203 in this case surrounds all of the edges or all sides and corners of the cell stack 201 and thus forms a type of frame, in which the cell stack 201 is fixed. Furthermore, the electronic component part 202 is embedded virtually completely in the injection-molded part. The injection-molded part 203 forms a coating on the surface of the electronic component part 202, the coating substantially completely surrounding the electronic component part 202 (for which reason it is illustrated by dashed lines; it is embedded substantially completely in the injection-molded part 203). Only the outer contact faces 204 and the test contacts 206 (which are of no significance, which has already been mentioned) are left uncovered.

The injection-molded part 203 therefore performs a plurality of functions. First, it fills all of the free interspaces between the cell stack 201 and the electronic component part 202 and therefore also surrounds the electrical conductors 205a and 205b between these two component parts. Furthermore, it acts as a structure-reinforcing element which imparts mechanical stability to the entire composite comprising the mentioned individual parts and holds the individual parts together. It forms, first, a type of frame, in which the cell stack 201 is fixed and, secondly, a housing for the electronic component part 202, with the housing surrounding the electronic component part substantially completely.

The notches depicted at the corners 207 and 208 are positioning aids (which are not essential to the invention), which can facilitate the insertion of the battery into a load. Also illustrated are the triangular projections 209 which have already been depicted in FIG. 1.

The injection-molded part 203 can be produced in particular from hotmelt adhesives based on polyamide, as mentioned above. The hotmelt adhesive “Macromelt 6832 S” by Henkel KgsA in Düsseldorf, for example, has proven to be particularly suitable.

1-12. (canceled)

13. A battery comprising a cell stack comprising at least one individual cell in a cell housing, an electronic component part, electrical conductors between the cell stack and the electronic component part and an injection-molded part which substantially completely surrounds the electrical conductors and is connected in form-fitting fashion both to the cell stack and to the electronic component part and connects the cell stack and the electronic component part to one another, outer contact faces of the battery also being integrated in the electronic component part in addition to at least one electronic circuit.

14. The battery as claimed in claim 13, wherein the injection-molded part forms a frame or a housing which surrounds at least part of the cell stack.

15. The battery as claimed in claim 13, wherein the injection-molded part forms a frame or a housing which surrounds the corners and edges of the cell stack.

16. The battery as claimed in claim 13, wherein the injection-molded part forms a frame or a housing which surrounds at least part of the electronic component part.

17. The battery as claimed in claim 13, wherein the injection-molded part forms a frame or a housing which surrounds corners and edges of the electronic component part.

18. The battery as claimed in claim 13, wherein the electronic component part substantially comprises a cured plastics part into which the outer contact faces of the battery are embedded.

19. The battery as claimed in claim 13, wherein the electronic component part substantially comprises a cured plastics part into which the outer contact faces of the battery and the at least one electronic circuit are embedded.

20. The battery as claimed in claim 13, wherein the at least one electronic circuit is a protective circuit.

21. The battery as claimed in claim 13, wherein the at least one individual cell in the cell stack is a lithium-ion cell or a lithium-polymer cell;

22. The battery as claimed in claim 13, wherein the cell housing of the cell stack is a film housing.

23. A method for producing a battery comprising:
arranging a cell stack comprising at least one individual cell in a cell housing and an electronic component part into which the outer contact faces of the battery are also integrated, in addition to at least one electronic circuit, in an injection mold;
filling remaining free space in the mold with a liquid plastics compound; and
curing contents of the mold.

24. The method as claimed in claim 23, wherein the cell stack and the electronic component part are brought into contact with one another by electrical conductors prior to being arranged in the injection mold.

25. The method as claimed in claim 23, wherein a thermoplastic hotmelt adhesive is the plastics compound.

26. The method as claimed in claim 23, wherein, a thermoplastic hotmelt adhesive on the basis of a polyamide is the plastics compound.

27. The method as claimed in claim 23, wherein the plastics compound is heated to a temperature of between 150° C. and 280° C. prior to filling the mold.

28. The method as claimed in claim 23, wherein the plastics compound and the injection mold are heated to a temperature of between 150° C. and 280° C. prior to filling the mold.

29. The method as claimed in claim 23, wherein the plastics compound is heated to a temperature of between 190° C. and 230° C. prior to filling the mold.

30. The method as claimed in claim 23, wherein the plastics compound and the injection mold are heated to a temperature of between 190° C. and 230° C. prior to filling the mold.

31. The method as claimed in claim 23, wherein the electronic component part is arranged in the injection mold such that the contact faces remain at least partially free from the liquid plastics compound.
